(19) United States
(12) Patent Application Publication
(10) Pub. No.: US 2006/0045710 A1
(43) Pub. Date: Mar. 2, 2006

(54) Hoist

(76) Inventor: David B. Hiebert, Rosenort (CA)

Correspondence Address: ADE & COMPANY, 1700-360 MAIN STREET, WINNIPEG, MB, R3C3Z3, CA

(21) Appl. No.: 11/020,559

(22) Filed: Dec. 27, 2004

(30) Foreign Application Priority Data
Aug. 27, 2004 (CA) 2,480,060

(51) Int. Cl. B66F 9/10

(52) U.S. Cl. 414/631

(57) ABSTRACT

A hoist includes two lift columns with a base for supporting the upright on a floor, the base projecting to a working side of the upright and a lift arm mounted for sliding movement up and down along the upright with the lift arm projecting to the working side of the upright. A safety mechanism, for limiting movement of the lift arm slide downwardly along the upright towards the base, has an upright rack and a latch engageable with teeth spaced along the rack with an upper cross member coupling the uprights of the two column assemblies at a position spaced above the bases thereof; and a lift mechanism for simultaneously raising and lowering the lift arm slides along the respective uprights.

The present invention relates to hoists and more particularly to a hoist or lift especially suited for use in a shop for small equipment, for example recreational vehicles (e.g. ATVs and snowmobiles), lawn mowers and garden tractors.

In the performance of service on small machines or components of larger machines, it is often useful to have free access to all sides of the equipment on which the work is to be performed, sides, back, top and bottom. While various hoists and lifts have been proposed for elevating equipment to provide improved access, most of these restrict access to the machine from one side, the ends or below making various forms of service work difficult.

The present invention addresses this problem and proposes a hoist that may be used to elevate the equipment while providing almost unrestricted access to all sides and from below.

### SUMMARY OF THE INVENTION

According to the present invention there is provided a hoist comprising:

two lift column assemblies, each assembly including:

an upright;

a base for supporting the upright on a floor, the base projecting to a working side of the upright;

a lift arm;

a lift arm slide mounting the lift arm for sliding movement up and down along the upright with the lift arm projecting to the working side of the upright;

a safety mechanism for limiting movement of the lift arm slide downwardly along the upright towards the base, the safety mechanism including an upright rack and a latch engageable with teeth spaced along the rack;

a cross member coupling the uprights of the two column assemblies at a position spaced above the bases thereof;

a lift mechanism for simultaneously raising and lowering the lift arm slides along the respective uprights.

In use, the hoist is positioned to one side of the equipment to be elevated with the column assembly placed just beyond each corner of the equipment and the lift arms spaced to the front and back respectively. Adapters on the lift arms are used to engage the equipment, usually the frame, at jacking positions where access is generally not required. The equipment may then be raised to provide substantially unfettered access to all sides of the equipment.

The safety mechanism is preferably designed to function at any elevation of the equipment.

Adaptors for raising any particular piece of equipment may be factory approved lift adapters to ensure that service work may be performed within the manufacturer's stipulated conditions.

### BRIEF DESCRIPTION OF THE DRAWINGS

In the accompanying drawings, which illustrate an exemplary embodiment of the present invention:

FIG. 1 is a perspective view of a hoist according to the invention.

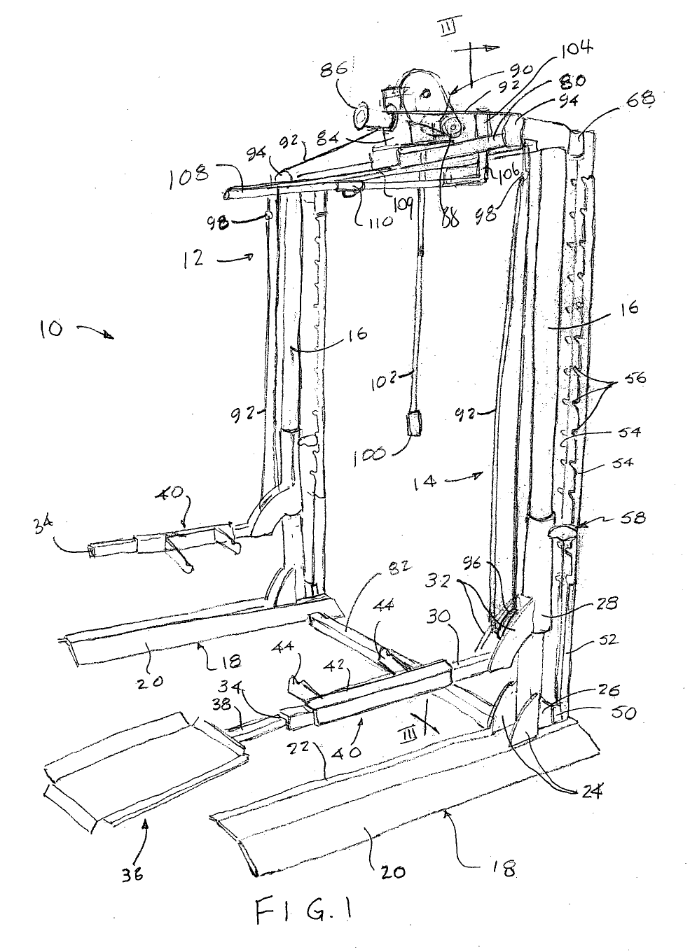

FIG. 2 is an elevation of the hoist of FIG. 1 from one end.

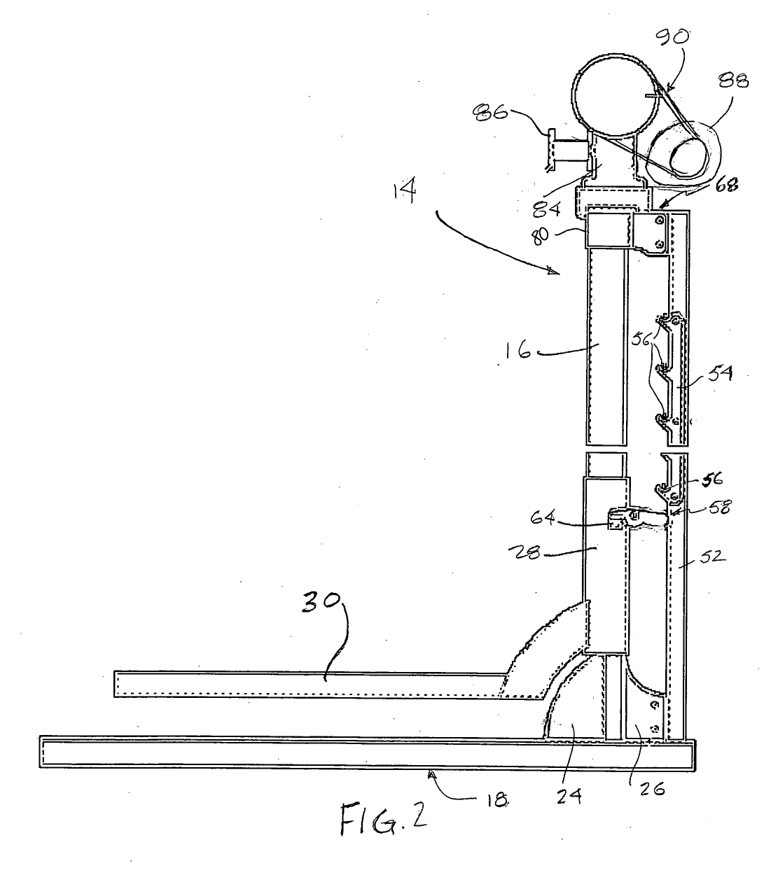

FIG. 3 is cross section of the hoist along line III-III of FIG. 1.

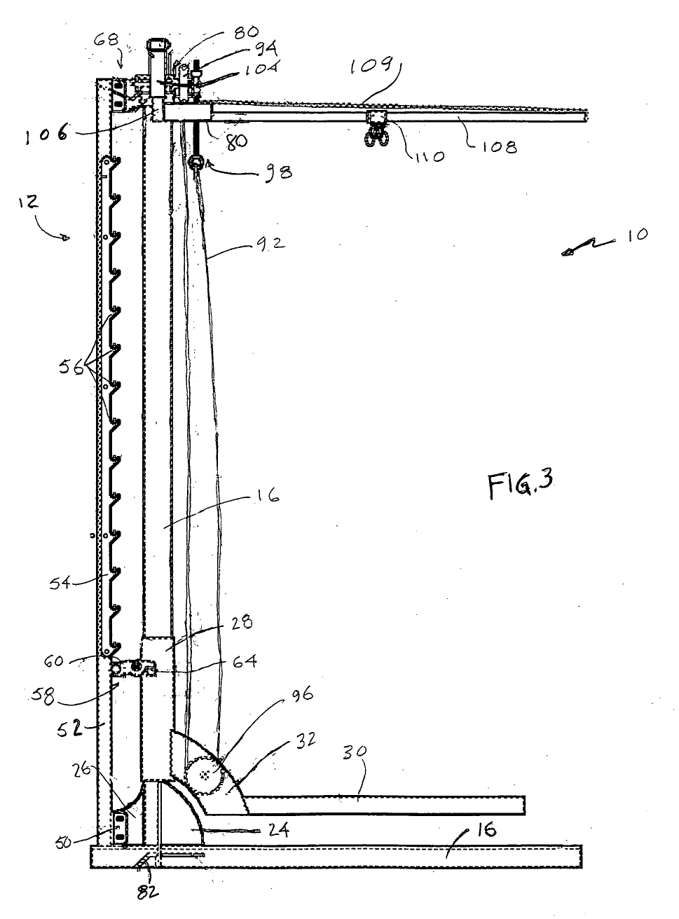

FIG. 4 is an isometric view of the safety mechanism of the hoist of FIG. 1.

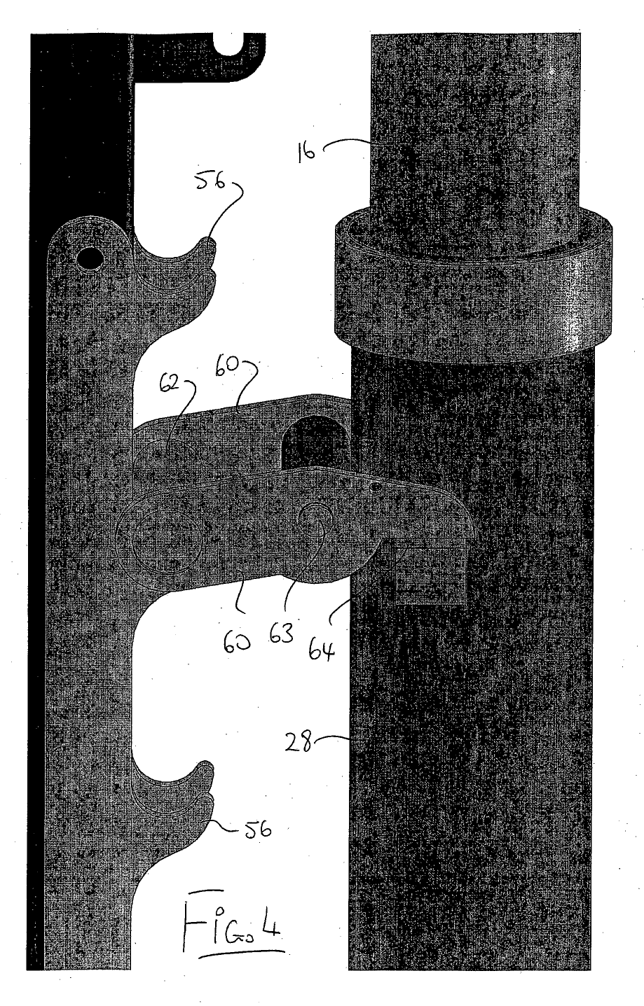

FIG. 5 is an isometric view of the lower pat only of the hoist of FIG. 1 showing a modified mounting for the lift adapter of FIG. 1.

### DETAILED DESCRIPTION

Referring to the accompanying drawings, there is illustrated a hoist 10 that includes two column assemblies 12 and 14 that are mirror symmetrical and spaced apart. Each column assembly includes an upright column 16 mounted on a base 18 that projects to a working side of the hoist where the equipment is located when it is to be raised. The base has ramps 20 and 22 on its opposite sides so that wheeled equipment can travel over it to and from the lifting position without undue obstruction.

The column 16 is supported on the base 18 by a pair of spaced gusset plates 24 on the working side, and by gussets 26 on the opposite side. The column 16 is cylindrical and carries a slide sleeve 28 that is configured to slide up and down on the column. A lift arm 30 projects from the slide sleeve to the working side of the hoist, above the base 18. A lift arm is mounted on the slide sleeve by two arcuate gusset plates 32. The lift arm is of square cross section and has an open outer end which serves as a socket 34. A tool tray 36 is mounted on a square section shaft 38, which slides into the end socket 34 of the lift arm to support the tool tray at the end of the arm.

Adapters 40 are used to mount equipment on the lift arms. Each adapter includes a square sleeve 42 that slides onto a lift arm 30 and lift members 44 projecting from the sleeve to engage the equipment, usually at a jack point and in a manner recommended b the equipment manufacturer. This arrangement makes it very simple to set the hoist up for various kinds of equipment from different manufacturers while still meeting the manufacturer's recommendations.

Each gusset 26 connects to a bracket 50, which supports a safety upright 52 on the side of the column opposite the working side. The safety upright 52 is a channel open to form two side walls forming racks 54 on the side confronting the column 16. Each rack 54 has a series of series of hooks or teeth 56 projecting from the upright towards the column. The safety mechanism also includes a latch or pawl 58 mounted on the slide sleeve 28. The latch includes two spaced side plates 60 and a cross pin 62 that is configured to engage in the hooks 56 of the safety rack. The side plates are pivotally mounted on a pin 63 of the latch bracket and spring biased to rotate the side plates in a clockwise direction bringing the pin 62 upwardly. A stop 64 on the slide sleeve 28 limits this pivotal movement at the 9.00 position. In use, as the slide sleeve ascends along the column, the latch and its pin 62 is deflected past the curved backside of each of the hooks 56 in turn so that should the slide sleeve be released, as it descends, the pin 62 will engage in the next lowest hook 56 to prevent uncontrolled descent.

The slide sleeve 28 is free to rotate on the column 16. The safety upright 54 is coupled to the upper end of the column 16 by a bracket 68.

In the hoist, the two column assemblies are joined by an upper cross member 80 which extends between the upper ends of the two columns and a lower cross member 82 which extends between the two bases 18. Mounted on the upper cross member 80 is a gearbox 84 carrying a cable drum 86. The gearbox is driven by a reversible electric motor 88 mounted on the cross member 80 beside the gear box through a pulley drive 90. Two cables 92 are wound on the drum 86. Each cable 92 extends from the drum to a respective end of the cross member 80 hoist where it passes over a sheave 94 mounted on the cross member 80 at the top of the respective column 16. Each cable then extends downwardly from sheave 94 and around a sheave 96 mounted between the lift arm gussets 32 and then back upwardly to a dead end cable anchor 98 at the top of the column, mounted on the cross member 80, thus forming a pulley system.

The motor 88 is controlled by a control box 100 on the end of a flexible electric cable 102 so that the hoist may be operated without restriction on the operator's position.

At the centre of the cross member 80 is an upright sleeve 104. A shaft 106 is mounted for rotation about the vertical axis of the sleeve 104. At its bottom end, the shaft 106 carries a engine suspension arm 108 that projects to the working side of the hoist. An engine hanger slide 110 is mounted slideably on the arm 108 and is equipped with fittings from which a chain or the like may be suspended. The arm 108 is supported by a brace 109 extending from the cross member shaft 106 to the free end of the arm. This subassembly is particularly useful for engine removal. For example, chains attached to the slide may be connected to the engine of a raised ATV or the like, and then the vehicle lowered to leave the engine suspended and out of the vehicle. For this use, and others where portability is desirable, the entire hoist may be mounted on wheels (not shown).

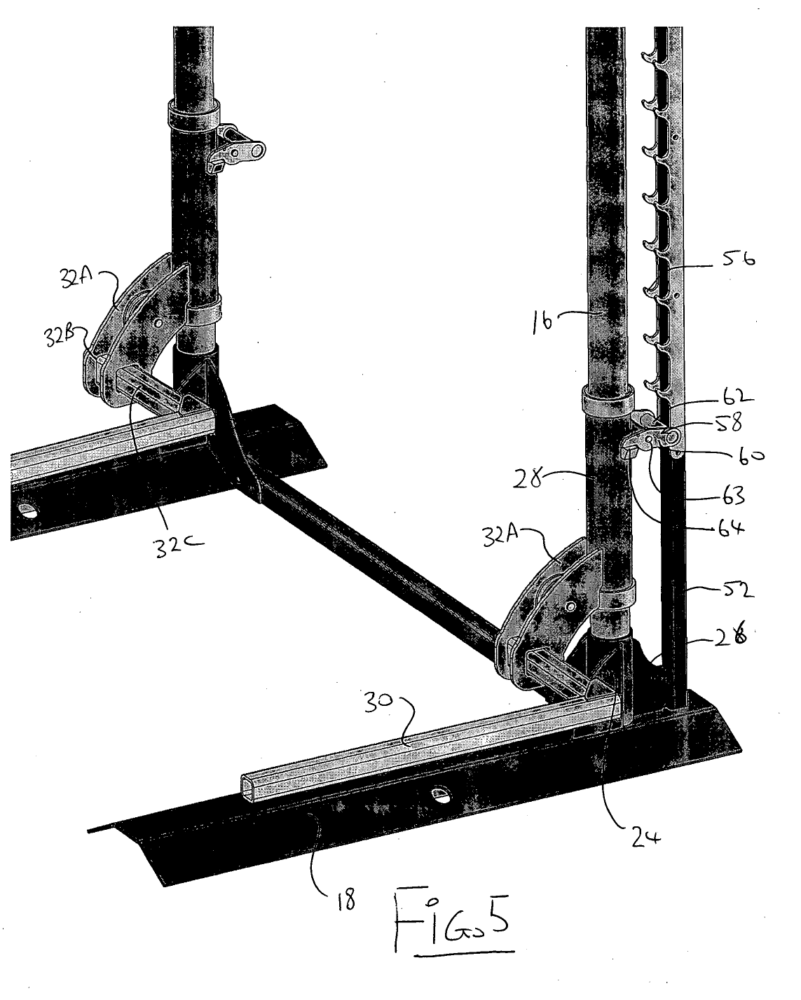

As shown in FIG. 5 there can be provided a modification by which the gussets 32A carried on the sleeve 28 have a transverse support hole 32B or generally square cross-section for receiving a transverse support beam 32C to which the arm 30 is attached. In this way the arm 30 is no longer aligned with the gussets 32A and it can be moved to the left or to the right of the gussets 32A to increase or decrease the spacing between the arms 30 and therefore between the lift adapters 40.

While one embodiment of the present invention has been described in detail in the foregoing, it is to be understood that other embodiments are possible within the scope of the invention. The invention is to be considered limited solely by the scope of the appended claims.

1. A hoist comprising:
two lift column assemblies, each assembly including:
an upright;
a base for supporting the upright on a floor, the base projecting to a working side of the upright;
a lift arm;
a lift arm slide mounting the lift arm for sliding movement up and down along the upright with the lift arm projecting to the working side of the upright;
a safety mechanism for limiting movement of the lift arm slide downwardly along the upright towards the base, the safety mechanism including an upright rack and a latch engageable with teeth spaced along the rack;
an upper cross member coupling the uprights of the two column assemblies at a position spaced above the bases thereof; and
a lift mechanism for simultaneously raising and lowering the lift arm slides along the respective uprights.

2. A hoist according to claim 1 wherein the lift mechanism comprises a winch drum and cable, the cable being wound on the winch drum and engaging each of the lift arm slides.

3. A hoist according to claim 1 including a lower cross member connecting the column assemblies adjacent their bases.

4. A hoist according to claim 3 wherein the winch is mounted on the upper cross member.

5. A hoist according to claim 1 including an engine suspension arm projecting from the upper cross member to the working side of the uprights and positioned therebetween.

6. A hoist according to claim 5 wherein the engine suspension arm is pivotally mounted on the upper cross member for pivotal movement about an upright axis.

7. A hoist according to claim 5 including an engine hanger mounted on the engine suspension arm and moveable therealong.

8. A hoist according to claim 1 wherein each lift arm comprises a socket at a free end thereof opposite the lift arm slide and including a tool tray with a tool tray support engageable in the socket to be supported by thereby.

9. A hoist according to claim 1 including support wheels mounted on the base, supporting the hoist for movement over a floor surface.
